(19) United States
(12) Patent Application Publication
(10) Pub. No.: US 2005/0202231 A1
(43) Pub. Date: Sep. 15, 2005

(54) Filter material for micro-filter

(75) Inventors: Atsuhiro Takata, Ichihara-shi, Chiba (JP); Ryuma Kuroda, Ichihara-shi Chiba (JP); Satoshi Hanada, Ichihara-shi Chiba (JP); Takeshi Yamada, Tsukuba-shi Ibaraki (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Chuo-ku, Tokyo (JP)

(21) Appl. No.: 10/515,586

(22) PCT Filed: May 14, 2003
(86) PCT No.: PCT/JP03/05965

§ 371 Date: Nov. 24, 2004

(30) Foreign Application Priority Data
May 28, 2002 (JP) 2002-153880

(51) Int. Cl. B32B 3/26; B32B 5/14

(52) U.S. Cl. 428/310.5; 428/304.4; 428/315.5

(57) ABSTRACT

A filter material for microfilters which is made of a micorporous film made of thermoplastic resin having micropores, the material being characterized in that the micropores are formed from a 3-dimensional network made of trunk fibrils extending in one direction of the film and branch fibrils through which the trunk fibrils are connected to one another, and the density of the branch fibrils is higher than the density of the trunk fibrils. This filter material is strength enough for practical use and also exhibits a high separation efficiency.

### TECHNICAL FIELD

The present invention relates to a filter material for microfilters which is made of polyolefin resin. More particularly, it relates to a filter material which can be employed suitably as a microfiltration membrane, an ultrafiltration membrane, a dialysis membrane, a reverse osmosis membrane or the like for use in microfilters.

### BACKGROUND ART

Porous films are known as filter materials in filters for filtering fluid containing an organic solvent or water as solvent. Such filter materials are required to exhibit a high separation efficiency and to have strength as high as they stand long-term use under pressure.

However, in the case of conventional porous membranes made of resin, especially porous polyolefin films, reduction in membrane thickness for improving the separation efficiency causes reduction in strength and pressure resistance. On the other hand, an attempt to enhance the strength results in reduction in separation efficiency. In other words, it is difficult for conventional porous resin membranes to enjoy simultaneously the improvement in separation efficiency and the improvement in strength and pressure resistance. Under such circumstances, there has been a demand for development of porous films suitable for use as filter materials for microfilters exhibiting a high separation efficiency and being excellent in strength and pressure resistance.

The object of the present invention is to provide a filter material for microfilters which is strong enough for practical use and which exhibits a high separation efficiency.

### DISCLOSURE OF INVENTION

The present inventors made investigations diligently to develop a microporous film suitable for use as a filter material for microfilters which is excellent in strength and pressure resistance while having a high separation efficiency. As a result, they found that making pores of a microporous film have a certain specific structure can result in a filter material for microfilter in which the above-mentioned problems have been overcome. Thus, they have accomplished the present invention.

The present invention is a filter material for microfilters which is made of a micorporous film made of thermoplastic resin having micropores, the material being characterized in that the micropores are formed from a 3-dimensional network made of trunk fibrils extending in one direction of the film and branch fibrils through which the trunk fibrils are connected to one another, and the density of the branch fibrils is higher than the density of the trunk fibrils. Filtering materials for microfilters having such a structure exhibit a high separation efficiency and also are excellent in strength.

Moreover, filter materials for microfilters according to the present invention have a good balance between the dynamic strength in the direction of maximum thermal shrinkage and that in the direction perpendicular thereto because the density of the branch fibrils is higher than the density of the trunk fibrils. In the filter material for microfilters according to the present invention, it is not always necessary for the branch fibrils and trunk fibrils to extend straight. The direction in which the trunk fibrils extend, which can be confirmed from an electron microphotograph, is not particularly limited since this direction depends upon the cutting direction of the film. In the present invention, the phrase “extending in one direction” does not require that all trunk fibrils extend in parallel in one specific direction, but it means that the trunk fibrils are oriented evenly in a specific direction while meandering to a certain degree.

The density of the branch fibrils and that of the trunk fibrils each refer to the number of the fibrils existing in a film surface having an area of 1 μm² and are determined through observation of the surface of the film using a scanning electron microscope. Specifically, the density is determined by counting the number of the fibrils existing in an area of 5 μm×5 μm. The pore structure of the filter material of the present invention is called a “loofah structure”.

In the above-mentioned filter material for microfilters, the average pore diameter d (μm) of the micropores determined by the bubble-point method provided in ASTM F316-86 and the average pore radius r (μm) of the micropores determined by mercury porosimetry provided in JIS K1150 preferably satisfy the following formula:
1.20≦2r/d≦1.70

If the value of 2r/d is less than 1.20, the filtering performance of the filter material may be insufficient. On the other hand, if it is over 1.70, the strength of the filter material may be insufficient. Moreover, from the viewpoint of the strength of a film, the value of 2r/d is preferably not more than 1.65, and more preferably not more than 1.60.

The thickness Y of the filter material for microfilters of the present invention made of a microporous film is generally from 1 to 200 μm, preferably from 5 to 100 μm and more preferably from 5 to 50 μm. If it is too large, a satisfactory filtering speed may not be achieved. If it is too small, the physical strength may be insufficient.

It is desirable for the above-mentioned filter material for microfilters that the branch fibrils be oriented in the maximum thermal shrinkage direction of the film. By orienting the branch fibrils in the maximum thermal shrinkage direction of the film, the film has a high mechanical strength in the maximum thermal shrinkage direction.

It is desirable for the filter material for microfilters of the present invention that the micropores have an average pore diameter of from 0.03 to 3 μm. Moreover, it is desirable that the Gurley value for a film thickness of 25 μm be from 10 to 500 sec/100 cc and the porosity be from 40 to 80%.

It should be noted that a filter material for microfilters may hereinafter be referred simply to as “filter material.”

### BRIEF DESCRIPTION OF THE DRAWINGS

FIG. 1 is a schematic view showing the structure of a cartridge manufactured by Advantec which was used for the filtering performance evaluation.

FIG. 2 is an electron microphotograph of the filter material for microfilters of Example 1.

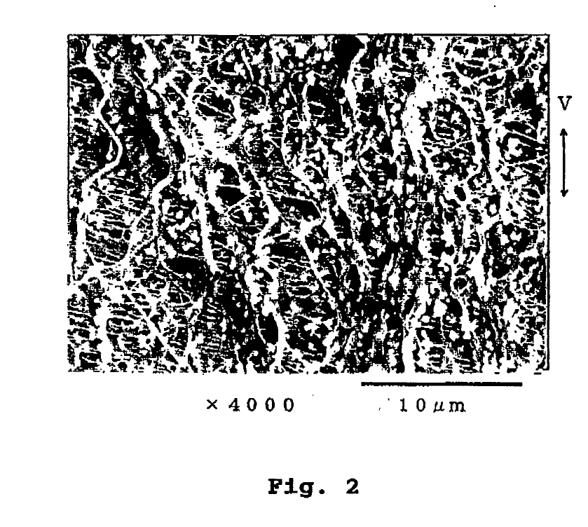

### BEST MODE FOR CARRYING OUT THE INVENTION

Examples of the thermoplastic resin which serves as the major starting material for the porous film which constitutes the filter material of the present invention include polyolefin resin, which is a homopolymer of olefin such as ethylene, propylene, butene and hexene or a copolymer of two or more kinds of olefin, acrylic resin such as polymethyl acrylate, polymethyl methacrylate and ethylene-ethyl acrylate copolymer, styrene resin such as butadiene-styrene copolymer, acrylonitrile-styrene copolymer, polystyrene, styrene-butadiene-styrene copolymer, styrene-isoprene-styrene copolymer and styrene-acrylic acid copolymer, vinyl chloride resin such as acrylonitrile-polyvinyl chloride and polyvinyl chloride-ethylene, vinyl fluoride resin such as polyvinyl fluoride and polyvinylidene fluoride, polyamide resin such as 6-nylon, 6,6-nylon and 12-nylon, saturated polyester resin such as polyethylene terephthalate and polybutylene terephthalate, polycarbonate, polyphenylene oxide, polyacetal, polyphenylene sulfide, silicone resin, thermoplastic polyurethane resin, polyether ether ketone, polyether imide, thermoplastic elastomer and their crosslinked products.

The thermoplastic resin constituting the filter material of the present invention may be either a single resin or a mixture of two or more resins.

Polyolefin resin is suitable as the thermoplastic resin for use in the filter material of the present invention because it is superior in chemical stability and is less prone to dissolution or swelling in many solvents.

Such polyolefin resin mainly comprises a polymer of a single kind of olefin or a copolymer of two or more kinds of olefin. Examples of olefin which serves as the starting material for the polyolefin resin include ethylene, propylene, butene and hexene. Specific examples of the polyolefin resin include polyethylene resin such as low-density polyethylene, linear polyethylene (ethylene-α-olefin copolymer) and high-density polyethylene, polypropylene resin such as polypropylene and ethylene-propylene copolymer, poly(4-methylpentene-1), poly(butene-1) and ethylene-vinyl acetate copolymer.

In particular, a filter material of the present invention which is made of a thermoplastic resin containing a high-molecular chain polyolefin having a molecular chain length of 2850 nm or more is superior in strength. Therefore, use of a thermoplastic resin containing an appropriate amount of high-molecular chain polyolefin having a molecular chain length of 2850 nm or more as a material for forming a filter material makes it possible to reduce the thickness of the filter material while maintaining good mechanical strength of the filter material. This can also improve the liquid permeability and, therefore, results in a filter material which exhibits the effect of the present invention more efficiently. From the viewpoint of the strength of a filter material, the thermoplastic resin in the filter material of the present invention preferably contains not less than 10% by weight, more preferably not less than 20% by weight, and even more preferably not less than 30% by weight of high-molecular chain polyolefin having a high-molecular chain length of 2850 nm or more.

The molecular chain length, the weight average molecular chain length, the molecular weight and the weight average molecular weight of the polyolefin can be determined by GPC (gel permeation chromatography). The proportions (% by weight) of mixed polyolefins in a specific molecular chain length range or a specific molecular weight range can be determined by integration of a molecular weight distribution curve obtained by GPC measurement.

In the present invention, the molecular chain length of polyolefin, which is a molecular chain length determined by GPC using polystyrene standards, is specifically a parameter determined by the following procedures.

As a mobile phase in GPC, a solvent is used which can dissolve both an unknown sample to be measured and standard polystyrenes with known molecular weights. First, a plurality of standard polystyrenes having different molecular weights are subjected to GPC measurement. Thus, the retention time of each standard polystyrene is determined. Using a Q factor of polystyrene, the molecular chain length of each standard polystyrene is determined, whereby the molecular chain length of each standard polystyrene and its corresponding retention time are determined. The molecular weight and the molecular chain length of each standard polystyrene and the Q factor are in the following relationship:
Molecular weight=Molecular chain length×Q factor

Then, an unknown sample is subjected to GPC measurement, whereby a (retention time)-(amount of eluted component) curve is produced. When the molecular chain length of a standard polystyrene whose retention time is T in the GPC measurement of a standard polystyrene is represented by L, the “molecular chain length in terms of polystyrene” of a component having a retention time of T determined in the GPC measurement of the unknown sample is defined as L. Using this relationship, the molecular chain length distribution in terms of polystyrene of the unknown sample (namely, the relationship between the molecular chain length in terms of polystyrene and the amount of the components eluted) is determined based on the (retention time)−(amount of eluted component) curve of the unknown sample.

The filter material of the present invention may contain fillers such as organic or inorganic fillers. Moreover, the filter material of the present invention may contain additives such as stretching aids, e.g. fatty esters and low-molecular polyolefin resin, stabilizers, antioxidants, UV absorbers and flame retardants.

When a polyolefin resin containing a long-molecular-chain polyolefin having a molecular chain length of 2850 nm or more is used as a starting material, the filter material of the present invention can be produced by kneading the starting resin together, if needed, with fine powders of an inorganic compound and/or resin using a twin-screw kneader having segments designed so as to achieve forcible kneading, converting the resulting kneaded mixture into a film by rolling, and stretching the resulting primary film with a stretching machine. As a device used for the stretching, conventional stretching machines can be used. A clip tenter is one example of preferable stretching machines.

Examples of the fine powders of an inorganic compound to be incorporated to the filter material of the present invention include aluminum oxide, aluminum hydroxide, magnesium oxide, magnesium hydroxide, hydrotalcite, zinc oxide, iron oxide, titanium oxide, calcium carbonate and magnesium carbonate each having an average particle diameter of from 0.1 to 1 μm. Particularly, for achieving a stable filtering performance, it is desirable to form a filter material for microfilters by using calcium carbonate or magnesium carbonate and dissolving and removing it with acidic water after the formation of a filter material for microfilters.

The thermoplastic resin constituting the filter material of the present invention may have been crosslinked by radiation exposure. The filter material of the present invention in which the thermoplastic resin having been crosslinked is superior in heat resistance and in strength to a filter material made of a non-crosslinked thermoplastic resin.

The filter material of the present invention preferably is a thin film having a thickness of from about 3 to about 50 μm. It is more preferable that the thermoplastic resin constituting the filter material has been crosslinked by radiation exposure. Usually, the strength of a filter material gets smaller with the reduction in thickness thereof. However, the filter material of the present invention preferably has a thickness of from about 3 to about 50 μm. Moreover, if the thermoplastic resin in the filter material of the present invention has been crosslinked, the filter material is particularly stable with regard to the filtering performance and it can be of high strength.

A filter material of the present invention in which the thermoplastic resin has been crosslinked can be obtained by further subjecting a filter material of the present invention produced by using a non-crosslinked thermoplastic resin to radiation exposure.

Although the type of radiation used for crosslinking is not particularly limited, gamma rays, alpha rays or electron beams are preferably used. Use of electron beams is particularly preferred from the viewpoint of production speed and safety.

As the source of radiation, an electron beam accelerator having an accelerating voltage of from 100 to 3000 kV is preferably used. If the accelerating voltage is lower than 100 kV, the depth of penetration of electron beams may be insufficient. An accelerating voltage higher than 3000 kV may require a large radiation exposure device and, therefore, is economically disadvantageous. Examples of the radiation exposure device include a Van de Graaff-type electron beam scanning device and an electron curtain-type electron beam-fixing conveyor-transferring device.

The absorbed dose of radiation is preferably from 0.1 to 100 Mrad, more preferably from 0.5 to 50 Mrad. If the absorbed dose is less than 0.1 Mrad, the effect of crosslinking the resin is insufficient. The case of being more than 100 Mrad is undesirable because the strength decreases greatly.

Although the atmosphere for radiation exposure may be air, inert gases such as nitrogen is preferred.

### EXAMPLES

Hereinafter, the present invention is descried in more detail by reference to Examples, which are not intended to limit the present invention.

The physical properties of the filter materials in the Examples and Comparative Examples were evaluated in the following evaluation methods.

[Evaluation Methods]

(1) Evaluation of Filtering Performance

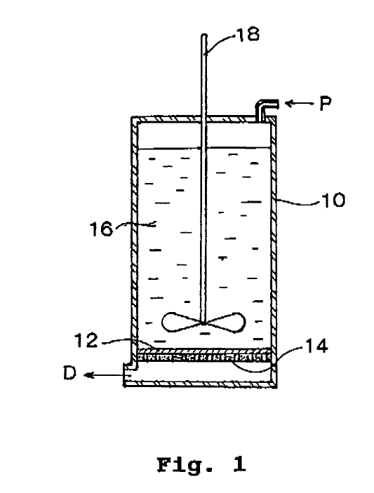

A filtering test was conducted using a cartridge 10 which was manufactured by Advantec and the outline of which is illustrated in FIG. 1. In the bottom of the cartridge 10, a porous film 12 serving as a filter is mounted so that it is supported with a support plate 14. Polystyrene latex 16 is introduced there into and filtration is conducted by pressurizing through a vent P while the latex is stirred with a stirrer 18. The filtrate is discharged through an outlet D.

As the polystyrene latex, PS latex Immutex (manufactured by JSR Corp.) having an average particle diameter of 0.2 μm was used. It was used after being diluted with water to a solid (resin particle) content of 0.1% by weight. The pressure was set to 0.2 MPa (2 kgf/cm²).

The separation efficiency was evaluated using the obstruction ratio of polystyrene latex particles calculated from the following formula.
Obstruction ratio (%)=100×[1−(solid content of filtrate)/(solid content of unfiltered solution)]

The unfiltered solution is the latex solution before filtration.

(2) Gurley Value

The Gurley value (sec/100 cc) of a film was measured according to JIS P8117 using a B-type densitometer (Toyo Seiki Seisaku-sho, LTD.).

(3) Average Pore Diameter

The average pore diameter d (μm) was measured by the bubble-point method according to ASTM P316-86 using a Perm-Porometer (manufactured by PMI Ltd.).

(4) Average Pore Radius

The average pore radius r (μm) was measured by mercury porosimetry according to JIS K1150 using an Auto-Pore III9420 (manufactured by MICROMERITICS, Ltd.). In the determination of the average pore radius, the pore radius distribution was measured within the range of from 0.0032 to 7.4 μm.

(5) Strength Against Penetration

When a metal needle having a diameter of 1 mm and a needle tip curvature radius of 0.5 mm was penetrated at a rate of 200 mm/min into a film fixed with a washer having a diameter of 12 mm, the maximum load at which a hole was formed in the film was measured. The strength against penetration was represented by that load.

[Preparation of Filter Material for Microfilters]

### EXAMPLE 1

A resin composition was obtained by kneading 30 vol % of calcium carbonate Starpigot 15A (produced by Shiraishi Calcium Co., Ltd., average particle diameter of 0.15 μm) together with 70 vol % of mixed polyethylene resin consisting of 70% by weight of polyethylene powder (HI-ZEX MILLION 340M, manufactured by Mitsui Chemicals, Inc.; weight average molecular chain length: 17000 nm; weight average molecular weight: 3,000,000; melting point: 136° C.) and 30% by weight of polyethylene wax (Hi-wax 110P, manufactured by Mitsui Chemicals, Inc.; weight average molecular weight: 1000; melting point 110° C.) by use of a twin-screw kneader having segments designed so as to achieve forcible kneading (produced by Research Laboratory of Plastics Technology Co., Ltd.). The content of polyethylene having a molecular chain length of 2850 nm or more in this resin composition was 27% by weight. A primary film about 70 μm in thickness was prepared by subjecting that resin composition to rolling (roll temperature: 150° C.).

The resulting primary film was stretched about 5-fold at a stretching temperature of 110° C. by use of a tenter stretching machine. Thus, a filter material for microfilters was obtained which was made of a porous film having a loofah structure. A scanning electron microphotograph of the surface of the resulting filter material is shown in FIG. 1. The somewhat thick fibers which are oriented while meandering in the V direction in FIG. 1 are trunk fibrils. Branch fibrils are formed in a direction perpendicular to the V direction. As is evident from FIG. 1, the density of branch fibrils is higher than that of trunk fibrils. A large number of micropores have been formed from branch fibrils and trunk fibrils.

The measurements of the separation efficiency, air permeability, thickness, average pore diameter d, average pore diameter r, 2r/d and strength against penetration of the filter material obtained in Example 1 are shown in Table 1.

### COMPARATIVE EXAMPLE 1

The measurements of the separation efficiency, air permeability, thickness, average pore diameter d, average pore diameter r, 2r/d and strength against penetration achieved when a commercially available porous film was used as a filter material are shown in Table 1. This porous film is a film produced by applying a crystallizing heat treatment to a laminate film having a layer structure polypropylene layer/polyethylene layer/polypropylene layer formed at a high draft ratio (take-off speed/extrusion speed), then stretching it at a low temperature, and then stretching it at a high temperature to cause exfoliation at crystal interfaces. This porous film does not have a loofah structure.

TABLE 1

| | | Comparative |
|---|---|---|
| | Example 1 | Example 1 |
| Obstruction ratio (%) | 99.95 | 99.93 |
| Gurley air permeation | 90 | 610 |
| (sec/100 cc) | | |
| Thickness (μm) | 42 | 25 |
| Average pore diameter | 0.129 | 0.050 |
| d (μm) | | |
| Average pore radius | 0.095 | 0.029 |
| r (μm) | | |
| 2r/d | 1.47 | 1.16 |
| Strength against penetration (N) | 6.9 | 3.3 |

As shown by the results in Table 1, it can be understood that the microporous film of the present invention of Example 1, which has a loofah structure, is superior in separation efficiency and is stronger in comparison with the porous film of Comparative Example 1 though the former is about 1.7 times thicker than the latter.

### INDUSTRIAL APPLICABILITY

The filter material for microfilters of the present invention can achieve a high separation efficiency and also can have a high strength because of its loofah structure. Therefore, this filter material can be employed suitably as a microfiltration membrane, an ultrafiltration membrane, a dialysis membrane, a reverse osmosis membrane, etc.

1. A filter material for microfilters which is made of a micorporous film made of thermoplastic resin having micropores, the material being characterized in that the micropores are formed from a 3-dimensional network made of trunk fibrils extending in one direction of the film and branch fibrils through which the trunk fibrils are connected to one another, and the density of the branch fibrils is higher than the density of the trunk fibrils.

2. The filter material for microfilters according to claim 1, wherein the average pore diameter d (μm) of the micropores as determined by the bubble-point method provided in ASTM F316-86 and the average pore radius r (μm) of the micropores as determined by mercury porosimetry provided in JIS K1150 preferably satisfy the following formula:
1.20≦2r/d≦1.70

3. The filter material for microfilters according to claim 1, wherein the branch fibrils are oriented in the maximum thermal shrinkage direction of the film.

4. The filter material for microfilters according to claim 1, wherein the micropores have an average pore diameter d of from 0.03 to 3 μm.

5. The filter material for microfilters according to claim 1, wherein the thermoplastic resin is polyolefin.

6. The filter material for microfilters according to claim 5, wherein the polyolefin comprises at least 10% or more of polyolefin having a molecular chain length of 2850 nm or more.
